(19) United States
(12) Patent Application Publication
(10) Pub. No.: US 2008/0318823 A1
(43) Pub. Date: Dec. 25, 2008

(54) Water-Soluble Detergent Composition for Cleaning Liquid Crystal and Preparation Method Thereof

(75) Inventors: Liu Dong, Guangdong (CN); Xuegang Chen, Guangdong (CN); Junqing Dong, Guangdong (CN); Qing Gong, Guangdong (CN); Zhinqi He, Guangdong (CN)

Correspondence Address: VOLPE AND KOENIG, P.C., UNITED PLAZA, SUITE 1600, 30 SOUTH 17TH STREET, PHILADELPHIA, PA, 19103, US

(73) Assignee: BYD COMPANY LIMITED, Longgang, Shenzhen (CN)

(21) Appl. No.: 12/096,965

(22) PCT Filed: Dec. 26, 2006
(86) PCT No.: PCT/CN2006/003599

§ 371 Date: Aug. 7, 2008

(30) Foreign Application Priority Data
Dec. 26, 2005 (CN) 200510132751.X

(51) Int. Cl. C11D 3/20

(52) U.S. Cl. 510/109

(57) ABSTRACT

A water soluble detergent composition for liquid crystal is presented. The composition includes 10-50 wt % of polyethylene glycol biester, 5-60 wt % of fatty alcohol polyoxyethylene ether, 5-20 wt % of alkyl tri-polyoxyethylene ether sulfate tri-fatty alcohol amine and/or alkenyl tri-polyoxyethylene ether sulfate tri-fatty alcohol amine, 1-15 wt % of alkyl benzene sulfonic acid, 1-10 wt % of lecithin, and 5-50 wt % of water. The detergent composition can effectively remove liquid crystal material invading into the gap of the liquid crystal panel, and foreign substances attached on the substrate surface.

### FIELD OF INVENTION

The present invention relates to a detergent composition for liquid crystal, and more specifically, relates to a water soluble detergent composition for liquid crystal material.

### BACKGROUND

The liquid crystal panel has been adopted for displaying various images, such as panels for computer terminal display, television screen, or cell phone, due to its low power consumption.

In a typical liquid crystal panel process, two glass substrates are allowed to be spaced by predetermined distance of less than 10 microns, and then bonded by adhesive to form an interspace therebetween; and then liquid crystal material is sealed in the interspace. Electrodes for displaying texts and images, which are formed by transparent conductive film, are provided in the two substrates, and when electrical signal is applied on the electrodes, display of texts and images can be controlled. In the aforementioned process for liquid crystal panel, a micron-scale width on the outer side of the jointing part of the two substrates is unavoidable, and thus it leads to an unavoidable gap. Therefore, when injected into the interspace between the two glass substrates, the liquid crystal material will invade into the gap due to the capillary action. Since contaminants in atmosphere may be dissolved into the liquid crystal material in the gap, and the gap is right located where electrical signal is applied on the transparent electrodes, insulation deterioration will be induced. Thus it is necessary to remove the liquid crystal material invading into the gap.

As the substrate interval at the gap is below 10 microns, which is very narrow, the detergent shall have high cleaning capability in order to completely remove the liquid crystal material. Among available detergents, halogen-containing organic solvents, such as fluoroalkane, trichloroethane, trichloroethene, tetrachloroethene, and dichloromethane, have relatively good effects. Unfortunately, as restriction on application of halogen-containing organic solvents is an important measure in world environment protection scheme, they are greatly limited in use.

Due to demand for development of detergent substitute, some novel detergents capable of replacing the aforementioned halogen-containing organic solvent have already been developed, which are hydrocarbon solvent or mixture of hydrocarbon solvent and polyethylene glycol ether. For example JP H10-25495A discloses a detergent capable of effectively cleaning stain on a liquid crystal box, which contains 5-95 wt % of saturated aliphatic hydrocarbon compound and/or saturated alicyclic hydrocarbon with a boiling point around 160-280° C. (such as decane or cyclododecatriene), and 5-95 wt % of ethylene glycol ether with general formula of R1-(O—CₙH₂ₙ)ₘ—O—R2 (in which R1 and R2 are H, alkyl or acyl, the total carbon number of R1 and R2 is 1-20, n is 2 or 3, and m is an integer within 1-3), such as ethylene glycol dimethyl ether. But this type of detergent has relatively poor cleaning capability and high combustibility.

Additionally, in liquid crystal panel production process, it is usually necessary to cut a master glass into smaller pieces of glass substrates, and a large amount of powder, which greatly interferes following packaging process, will be generated during the cutting process and must be removed. The foreign substances on the surface such as glass powder are usually attached on the surface of the liquid crystal panel via molecular interaction, and also can be tightly adhered on the liquid crystal panel via the liquid crystal material as bonding agent; therefore the detergent for removing foreign matter on the surface of the panel is required to have higher cleaning capability. Available detergents for glass powder, such as alkaline detergent disclosed in JP H5-271699A, H7-305093A, and 2001-181699A, not only are likely to damage the liquid crystal panel, but also can not effectively remove glass powder tightly adhered on the panel via the liquid crystal material as bonder.

With development of high density technique of liquid crystal panel in recent years, the gap interval between the panel substrates is further narrowed, and moreover, due to the demand for increasing the productivity and the qualification rate of liquid crystal panel, the detergent is required to have high cleaning capacity of cleaning the liquid crystal panel within short time, not only removing the liquid crystal material invading into the gap, but also simultaneously removing foreign substances on surface of the electrode terminal. In addition, available STN liquid crystal material is usually an aromatic compound with cyano as representative substituent, while TFT liquid crystal material is usually an aromatic compound with fluorine atom as representative substituent. As STN liquid crystal material and TFT liquid crystal material are different in molecular structure and physical properties, it is required to develop multi-purpose detergent compositions applicable to various liquid crystal materials with different molecular structures and physical properties.

### SUMMARY

An object of the present invention is to overcome the disadvantages of the detergents of the prior art that the liquid crystal material can not be effectively cleaned and the liquid crystal material in gap between substrates of liquid crystal panel and foreign substances attached on surface of the liquid crystal panel can not be simultaneously removed, and to provide a detergent applicable to various liquid crystal materials, which can simultaneously effectively remove the liquid crystal material in gap between substrates of liquid crystal panel and foreign substances attached on surface of the liquid crystal panel.

The present invention provides a water soluble detergent composition, containing 10-50 wt % of polyethylene glycol biester, 5-60 wt % of fatty alcohol polyoxyethylene ether, 5-20 wt % of alkyl tri-polyoxyethylene ether sulfate tri-fatty alcohol amine and/or alkenyl tri-polyoxyethylene ether sulfate tri-fatty alcohol amine, 1-15 wt % of alkyl benzene sulfonic acid, 1-10 wt % of lecithin, and 5-50 wt % of water based on the total amount of the composition.

The present invention also provides a method for preparing the detergent composition for liquid crystal, comprising mixing polyethylene glycol biester, fatty alcohol polyoxyethylene ether, alkyl tri-polyoxyethylene ether sulfate tri-fatty alcohol amine and/or alkenyl tri-polyoxyethylene ether sulfate tri-fatty alcohol amine, alkyl benzene sulfonic acid, lecithin and water, wherein the usage of each component is such that the obtained detergent composition contains 10-50 wt % of polyethylene glycol biester, 5-60 wt % of fatty alcohol polyoxyethylene ether, 5-20 wt % of alkyl tri-polyoxyethylene ether sulfate tri-fatty alcohol amine and/or alkenyl tri-polyoxyethylene ether sulfate tri-fatty alcohol amine, 1-15 wt % of alkyl benzene sulfonic acid, 1-10 wt % of lecithin, and 5-50 wt % of water based on its total amount.

The water soluble detergent composition for liquid crystal material according to the present invention is dissolvable in water, can effectively remove liquid crystal material invading into the gap of the liquid crystal panel, and have high penetration capability for foreign substances such as glass powder attached on the substrate surface to effectively remove them, which is a detergent composition with good cleaning capability for various liquid crystal materials, less toxicity, environment friendliness, and low combustibility.

### DETAILED DESCRIPTION OF THE PREFERRED EMBODIMENTS

According to the present invention, the polyethylene glycol biester has functions of cleaning and thickening, and may be represented by the general formula as below:

R₁COO—(CH₂—CH₂—O—CH₂—CH₂—O)ₙ—OC—R₂

in which, R₁ and R₂ can be same or different, being an alkyl or alkenyl with 3-15, preferably 5-13 carbon atoms, and preferably R₁ and R₂ are same, and are pentyl, hexyl, heptyl, octyl, nonyl, decyl, undecyl, lauryl, tridecyl, pentenyl, hexenyl, heptenyl, octenyl, nonenyl, decenyl, undecenyl, or dodecenyl; and n is an integer of 3-15, preferably 5-12. The alkyl can be linear or branched alkyl, and the structure of the alkyl and the position the double bond in the alkenyl will not affect the function of the compound in the present invention.

The polyethylene glycol biester is preferably one or more selected from decaethylene glycol dilaurate, decaethylene glycol ditridecylate, and decaethylene glycol diundecylenate.

Based on the total weight of the detergent composition, the content of the polyethylene glycol biester is preferably 10-40 wt %.

The fatty alcohol polyoxyethylene ether has the function of cleaning and emulsification, and may be represented by the general formula as below:

RO—(CH₂—CH₂—O)ₙ—H

in which R is an alkyl or alkenyl with carbon atoms of 8-14, preferably 9-12, and can be nonyl, decyl, undecyl, lauryl, nonenyl, decenyl, undecenyl, or dodecenyl; and n is an integer of 5-15, preferably 6-12. The alkyl can be linear or branched alkyl, and the structure of the alkyl and the position of the double bond in the alkenyl will not effect the function of the compound in the present invention.

The fatty alcohol polyoxyethylene ether is preferably one or more selected from nonyl hexaoxyethylene ether, decyl octaoxyethylene ether, lauryl hexaoxyethlene ether, lauryl decaoxyethylene ether, undecenyl hexaoxyethylene ether, and dodecenyl undecaoxyethylene ether.

Based on the total weight of the detergent composition, the content of the fatty alcohol polyoxyethylene ether is preferably 30-50 wt %.

The alkyl tri-polyoxyethylene ether sulfate fatty alcohol amine and/or alkenyl tri-polyoxyethylene ether sulfate fatty alcohol amine can improve the dispersion and compatibility of the detergent composition, an may be represented by the general formula as below:

RO—(CH₂—CH₂—O)₃—SO₃HNR₃′

in which R is an alkyl or alkenyl with 8-14, preferably 10-13 carbon atoms, and can be decyl, undecyl, lauryl, tridecyl, decenyl, undecenyl, or dodecenyl; and R′ is a fatty alcohol with 1-4, preferably 1-3 carbon atoms, such as methanol, ethanol, or propanol. The alkyl can be linear or branched alkyl, and the structure the alkyl and the position of the double bond in the alkenyl will not affect the function of the compound in the present invention.

The alkyl tri-polyethylene ether sulfate fatty alcohol amine and/or alkenyl tri-polyethylene ether sulfate fatty alcohol amine are preferably one or more selected from undecyl trioxyethylene ether sulfate triethanolamine, lauryl trioxyethylene ether sulfate triethanolamine, tridecyl trioxyethylene ether sulfate triethanolamine, lauryl trioxyethylene ether sulfate trimethanolamine, lauryl trioxyethylene ether sulfate tripropanolamine, undecenyl trioxyethylene ether sulfate triethanolamine, dodecenyl trioxyethylene ether sulfate trimethanolamine, and dodecenyl trioxyethylene ether sulfate tripropanolamine.

Based on the total weight of the detergent composition, the content of the alkyl tri-polyethylene ether sulfate fatty alcohol amine and/or alkenyl tri-polyethylene ether sulfate fatty alcohol amine is preferably 5-15 wt %. The alkyl benzene sulfonic acid has functions of removing dirt and improving the penetration, and may be represented by the general formula as below:

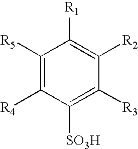

in which R₁-R₆ can be same or different, being H or an alkyl with 6-15, preferably 8-13 carbon atoms.

The alkyl benzene sulfonic acid is preferably one or more selected from octyl benzene sulfonic acid, nonyl benzene sulfonic acid, decyl benzene sulfonic acid, undecyl benzene sulfonic acid, lauryl benzene sulfonic acid, and tridecyl sulfonic acid. In the alkyl benzene sulfonic acid, the alkyl can be at ortho-, meta-, or para-position of the sulfonic group, preferably para-position, and the position and structure of alkyl will not affect the function of the compound in the present invention.

Based on the total weight of the detergent composition, the content of the alkyl benzene sulfonic acid is preferably 5-15 wt %.

The lecithin has dispersion and antioxidation functions; and its content is preferably 2-5 wt % based on the total weight of the detergent composition.

Based on the total weight of the detergent composition, the content of water is preferably 10-20 wt %.

The method for preparing the detergent composition comprises mixing polyethylene glycol biester, fatty alcohol polyoxyethylene ether, alkyl tri-polyoxyethylene ether sulfate tri-fatty alcohol amine and/or alkenyl tri-polyoxyethylene ether sulfate tri-fatty alcohol amine, alkyl benzene sulfonic acid, lecithin and water to obtain a water soluble detergent composition preferably containing, based on the total weight of the composition, 10-40 wt % of polyethylene glycol biester, 30-50 wt % of fatty alcohol polyoxyethylene ether, 5-15 wt % of alkyl tri-polyoxyethylene ether sulfate tri-fatty alcohol amine and/or alkenyl tri-polyoxyethylene ether sulfate tri-fatty alcohol amine, 5-15 wt % of alkyl benzene sulfonic acid, 2-5 wt % of lecithin, and 10-20 wt % of water.

Preferably the mixing is carried out under stirring, at room temperature. According to the present invention, the method for cleaning liquid crystal material using the detergent composition can be any method well known for those skilled in the art. For example, the method may comprise contacting the liquid crystal material to be cleaned, such as liquid crystal box, with the detergent composition at a temperature of 30-80° C., preferably 45-65° C., for 5-45 min, preferably 10-35 min. Preferably, the contacting is carried out by soaking the liquid crystal box in the detergent composition, and preferably under ultrasound.

According to the present invention, after being cleaned by the detergent composition, the liquid crystal box may be further washed sequentially with 0.1-5 wt % alkaline solution (such as KOH or NaOH), and distilled water. After being washed, the liquid crystal box may be further dried by the drying method under the drying condition well known for those skilled in the art.

The present invention will be further described through the following examples.

### EXAMPLE 1

This Example describes the preparation and use of the detergent composition according to the present invention.

Decaethylene glycol dilaurate 25 weight parts, lauryl hexaoxyethylene ether 40 weight parts and lauryl decaoxyethylene ether 5 weight parts, lauryl trioxyethylene ether sulfate triethanolamine 10 weight parts, p-octyl benzene sulfonic acid 8 weight parts, lecithin 2 weight parts, and deionized water 10 weight parts were uniformly mixed to give detergent composition A1.

The above obtained detergent composition was heated to 50° C., and 50 liquid crystal boxes (Model No. 280A from BYD Co. Ltd.) were soaked therein, stirred under ultrasound for 20 min, then taken out, washed sequentially with 1 wt % KOH solution and distilled water, and finally dried at 100° C. for 2 hr to obtain the cleaned liquid crystal boxes.

### EXAMPLE 2

This example describes the method for cleaning the liquid crystal box by using the detergent composition according to the present invention.

Decaethylene glycol ditridecylate 20 weight parts, nonyl hexaoxyethylene ether 40 weight parts, undecyl trioxyethylene ether sulfate triethanolamine 10 weight parts, p-decyl benzene sulfonic acid 10 weight parts, lecithin 2 weight parts, and deionized water 18 weight parts were uniformly mixed to give detergent composition A2.

The above obtained detergent composition was heated to 50□, and 50 liquid crystal boxes (Model No. 280A from BYD Co. Ltd.) were soaked therein, stirred under ultrasound for 10 min, then taken out, washed sequentially with 1 wt % KOH solution and distilled water, and finally dried at 100□ for 2 hr to obtain the cleaned liquid crystal boxes.

### EXAMPLE 3

This example describes the method for cleaning liquid crystal box by using the detergent composition according to the present invention.

Decaethylene glycol dilaurate 15 weight parts, decyl octaoxyethylene ether 30 weight parts, nonyl hexaoxyethylene ether 5 weight parts, 11-dodecenyl undecaoxyethylene ether 5 weight parts, tridecyl trioxyethylene ether sulfate triethanolamine 10 weight parts, o-lauryl benzene sulfonic acid 5 weight parts and p-octyl benzene sulfonic acid 5 weight parts, lecithin 5 weight parts, and deionized water 20 weight parts were uniformly mixed to give detergent composition A3.

The above obtained detergent composition was heated to 55° C., and 50 liquid crystal boxes (Model No. 280A from BYD Co. Ltd.) were soaked therein, stirred under ultrasound for 15 min, then taken out, washed sequentially with 1 wt % KOH solution and distilled water, and finally dried at 100° C. for 2 hr to obtain the cleaned liquid crystal boxes.

### EXAMPLE 4

This example describes the method for cleaning liquid crystal box by using the detergent composition according to the present invention.

Decaethylene glycol ditridecylate 10 weight parts, decaethylene glycol dilaurate 25 weight parts, lauryl hexaoxyethylene ether 40 weight parts, lauryl trioxyethylene ether sulfate trimethanolamine 5 weight parts, p-undecyl benzene sulfonic acid 5 weight parts, lecithin 5 weight parts, and deionized water 10 weight parts were uniformly mixed to give detergent composition A4.

The above obtained detergent composition was heated to 50□, and 50 liquid crystal boxes (Model No. 280A from BYD Co. Ltd.) were soaked therein, stirred under ultrasound for 25 min, then taken out, washed sequentially with 1 wt % KOH solution and distilled water, and finally dried at 100□ for 2 hr to obtain the cleaned liquid crystal boxes.

### EXAMPLE 5

This example describes the method for cleaning liquid crystal box by using the detergent composition according to the present invention.

Decaethylene glycol diundecylate 15 weight parts, lauryl hexaoxyethylene ether 35 weight parts, lauryl trioxyethylene ether sulfate tripropanolamine 15 weight parts, p-octyl benzene sulfonic acid 15 weight parts, lecithin 5 weight parts, and deionized water 15 weight parts were uniformly mixed to give detergent composition A5.

The above obtained detergent composition was heated to 45° C., and 50 liquid crystal boxes (Model No. 280A from BYD Co. Ltd.) were soaked therein, stirred under ultrasound for 10 min, then taken out, washed sequentially with 1 wt % KOH solution and distilled water, and finally dried at 100° C. for 2 hr to obtain the cleaned liquid crystal boxes.

### EXAMPLE 6

This example describes the method for cleaning liquid crystal box by using the detergent composition according to the present invention.

Decaethylene glycol dilaurate 38 weight parts, decyl octaoxyethylene ether 30 weight parts, 10-dodecenyl trioxyethylene ether sulfate tripropanolamine 6 weight parts, 11-dodecenyl trioxyethylene ether sulfate triethanolamine 2 weight parts, p-undecyl benzene sulfonic acid 7 weight parts, lecithin 3 weight parts, and deionized water 15 weight parts were uniformly mixed to give detergent composition A6.

The above obtained detergent composition was heated to 50° C., and 50 liquid crystal boxes (Model No. 280A from BYD Co. Ltd.) were soaked therein, stirred under ultrasound for 10 min, then taken out, washed sequentially with 1 wt % KOH solution and distilled water, and finally dried at 100° C. for 2 hr to obtain the cleaned liquid crystal boxes.

### EXAMPLE 7

This example describes the method for cleaning liquid crystal box by using the detergent composition according to the present invention.

Decaethylene glycol di-10-undecylenate 12 weight parts, 9-undecylenyl hexaoxyethylene ether 50 weight parts, lauryl trioxyethylene ether sulfate triethanolamine 12 weight parts, p-octyl benzene sulfonic acid 8 weight parts, lecithin 4 weight parts, and deionized water 14 weight parts were uniformly mixed to give detergent composition A7.

The above obtained detergent composition was heated to 60° C., and 50 liquid crystal boxes (Model No. 280A from BYD Co. Ltd.) were soaked therein, stirred under ultrasound for 10 min, then taken out, washed sequentially with 1 wt % KOH solution and distilled water, and finally dried at 100° C. for 2 hr to obtain the cleaned liquid crystal boxes.

### COMPARISON EXAMPLE 1

This example describes the method for cleaning liquid crystal box by using conventional detergent composition.

Liquid crystal boxes were cleaned according to the same method in example 1, except that the adopted detergent is a detergent with Model No. CFC113, which is denoted as B1.

### EXAMPLES 8-14

In these examples, the cleaning rate was determined for the liquid crystal boxes cleaned by the detergents A1-A7 prepared in examples 1-7.

Cleaning Rate Test:

The cleaning rate refers to qualification rate of the cleaned liquid crystal boxes. The glass panel of the cleaned liquid crystal box is observed under microscope. If there is no residual liquid crystal or foreign substances on the surface, the liquid crystal box is the qualified product. The cleaning rate can be obtained by following equation:

cleaning rate=(number of qualified products/total number of the cleaned liquid crystal boxes)×100%.

The result is as shown in Table 1

### COMPARISON EXAMPLE 2

The liquid crystal boxes cleaned with the detergent in the comparison example 1 are subjected to cleaning rate test according to the same method in examples 8-14.

The result is shown in Table 1

TABLE 1

| Example No. | Detergent Composition No. | Cleaning rate |
|---|---|---|
| example 8 | A1 | 98% |
| example 9 | A2 | 94% |
| example 10 | A3 | 95% |
| example 11 | A4 | 95% |
| example 12 | A5 | 94% |
| example 13 | A6 | 96% |
| example 14 | A7 | 93% |
| comparison example 2 | B1 | 90% |

It can be observed from the above result that, the water soluble detergent composition for liquid crystal according to the present invention has significantly improved cleaning effect compared with the conventional detergent, as the cleaning rate of the glass panel of the liquid crystal box cleaned by conventional detergent CFC113 is only about 90%.

1. A water soluble detergent composition for liquid crystal, comprising 10-50 wt % of polyethylene glycol biester, 5-60 wt % of fatty alcohol polyoxyethylene ether, 5-20 wt % of at least one of alkyl tri-polyoxyethylene ether sulfate tri-fatty alcohol amine or alkenyl tri-polyoxyethylene ether sulfate tri-fatty alcohol amine, 1-15 wt % of alkyl benzene sulfonic acid, 1-10 wt % of lecithin, and 5-50 wt % of water based on the total amount of the composition.

2. The composition according to claim 1, wherein based on total weight of the composition, the content of polyethylene glycol biester is 10-40 wt %, the content of fatty alcohol polyoxyethylene ether is 30-50 wt %, the content of at least one of alkyl tri-polyoxyethylene ether sulfate tri-fatty alcohol amine or alkenyl tri-polyoxyethylene ether sulfate tri-fatty alcohol amine is 5-15 wt %, the content of alkyl benzene sulfonic acid is 5-15 wt %, the content of lecithin is 2-5 wt %, and the content of water is 10-20 wt %.

3. The composition according to claim 1, wherein the polyethylene glycol biester is represented by the general formula as below:
R₁COO—(CH₂—CH₂—O—CH₂—CH₂—O)ₙ—OC—R₂
in which, R₁ and R₂ is same or different, being an alkyl or alkenyl with 3-15 carbon atoms; and
n is an integer from 3-15, inclusive.

4. The composition according to claim 3, wherein R₁ and R₂ are same, and are pentyl, hexyl, heptyl, octyl, nonyl, decyl, undecyl, lauryl, tridecyl, pentenyl, hexenyl, heptenyl, octenyl, nonenyl, decenyl, undecenyl, or dodecenyl; and n is an integer from 5-12, inclusive.

5. The composition according to claim 3, wherein the polyethylene glycol biester is selected from the group consisting of: decaethylene glycol dilaurate, decaethylene glycol ditridecylate, decaethylene glycol diundecylenate and combinations thereof.

6. The composition according to claim 1, wherein the fatty alcohol polyoxyethylene ether is represented by the general formula as below:
RO—(CH₂—CH₂—O)ₙ—H
in which R is an alkyl or alkenyl with 8-14 carbon atoms, and n is an integer from 5-15 inclusive.

7. The composition according to claim 6, wherein R is nonyl, decyl, undecyl, lauryl, nonenyl, decenyl, undecenyl, or dodecenyl; and n is an integer from 6-12 inclusive.

8. The composition according to claim 6, wherein the fatty alcohol polyoxyethylene ether is selected from the group consisting of nonyl hexaoxyethylene ether, decyl octaoxyethylene ether, lauryl hexaoxyethlene ether, lauryl decaoxyethylene ether, undecenyl hexaoxyethylene ether, dodecenyl undecaoxyethylene ether and combinations thereof.

9. The composition according to claim 1, wherein at least one of the alkyl tri-polyoxyethylene ether sulfate fatty alcohol amine or alkenyl tri-polyoxyethylene ether sulfate fatty alcohol amine are represented by the general formula as below:
RO—(CH₂—CH₂—O)₃—SO₃HNR₃′
in which R is an alkyl or alkenyl with 8-14 carbon atoms, and R′ is a fatty alcohol with 1-4 carbon atoms.

10. The composition according to claim 9, wherein R is decyl, undecyl, lauryl, tridecyl, decenyl, undecenyl, or dodecenyl, and R′ is methanol, ethanol, or propanol.

11. The composition according to claim 9, wherein at least one of the alkyl tri-polyethylene ether sulfate fatty alcohol amine or alkenyl tri-polyethylene ether sulfate fatty alcohol amine are selected from the group consisting of undecyl trioxyethylene ether sulfate triethanolamine, lauryl trioxyethylene ether sulfate triethanolamine, tridecyl trioxyethylene ether sulfate triethanolamine, lauryl trioxyethylene ether sulfate trimethanolamine, lauryl trioxyethylene ether sulfate tripropanolamine, undecenyl trioxyethylene ether sulfate triethanolamine, dodecenyl trioxyethylene ether sulfate trimethanolamine, dodecenyl trioxyethylene ether sulfate tripropanolamine and combinations thereof.

12. The composition according to claim 1, wherein the alkyl benzene sulfonic acid is represented by the general formula as below: 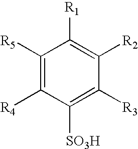
in which R₁, R₂, R₃, R₄, R₅, and R₆ are same or different, being H or an alkyl with 6-15 carbon atoms.

13. The composition according to claim 12, wherein the alkyl benzene sulfonic acid is one or more selected from octyl benzene sulfonic acid, nonyl benzene sulfonic acid, decyl benzene sulfonic acid, undecyl benzene sulfonic acid, lauryl benzene sulfonic acid, and tridecyl sulfonic acid.

14. A method for preparing the composition of claim 1, mixing polyethylene glycol biester, fatty alcohol polyoxyethylene ether, at least one of alkyl tri-polyoxyethylene ether sulfate tri-fatty alcohol amine or alkenyl tri-polyoxyethylene ether sulfate tri-fatty alcohol amine, alkyl benzene sulfonic acid, lecithin and water, wherein the usage of each component is such that the obtained detergent composition contains polyethylene glycol biester 10-50 wt %, fatty alcohol polyoxyethylene ether 5-60 wt %, at least one of alkyl tri-polyoxyethylene ether sulfate tri-fatty alcohol amine or alkenyl tri-polyoxyethylene ether sulfate tri-fatty alcohol amine 5-20 wt %, alkyl benzene sulfonic acid 1-16 wt %, lecithin 1-10 wt %, and water 5-60 wt % based on its total amount.

15. The method according to claim 14, wherein the usage of each component is such that the obtained detergent composition contains polyethylene glycol biester 10-40 wt %, fatty alcohol polyoxyethylene ether 30-60 wt %, at least one of alkyl tri-polyoxyethylene ether sulfate tri-fatty alcohol amine or alkenyl tri-polyoxyethylene ether sulfate tri-fatty alcohol amine 5-16 wt %, alkyl benzene sulfonic acid 5-16 wt %, lecithin 2-6 wt %, and water 10-20 wt % based on its total amount.

16. The method according to claim 14, wherein the polyethylene glycol biester is selected from the group consisting of: decaethylene glycol dilaurate, decaethylene glycol ditridecylate, decaethylene glycol diundecylenate and combinations thereof.

17. The method according to claim 14, wherein the fatty alcohol polyoxyethylene ether is selected from the group consisting of:
nonyl hexaoxyethylene ether, decyl octaoxyethylene ether, lauryl hexaoxyethlene ether, lauryl decaoxyethylene ether, undecenyl hexaoxyethylene ether, dodecenyl undecaoxyethylene ether and combinations thereof.

18. The method according to claim 14, wherein at least one of the alkyl tri-polyethylene ether sulfate fatty alcohol amine or alkenyl tri-polyethylene ether sulfate fatty alcohol amine are selected from the group consisting of undecyl trioxyethylene ether sulfate triethanolamine, lauryl trioxyethylene ether sulfate triethanolamine, tridecyl trioxyethylene ether sulfate triethanolamine, lauryl trioxyethylene ether sulfate trimethanolamine, lauryl trioxyethylene ether sulfate tripropanolamine, undecenyl trioxyethylene ether sulfate triethanolamine, dodecenyl trioxyethylene ether sulfate trimethanolamine, dodecenyl trioxyethylene ether sulfate tripropanolamine and combinations thereof.

19. The method according to claim 14, wherein the alkyl benzene sulfonic acid is selected from the group consisting of: octyl benzene sulfonic acid, nonyl benzene sulfonic acid, decyl benzene sulfonic acid, undecyl benzene sulfonic acid, lauryl benzene sulfonic acid, tridecyl sulfonic acid and combinations thereof.
